(19) United States
(12) Patent Application Publication
(10) Pub. No.: US 2026/0067858 A1
(43) Pub. Date: Mar. 5, 2026

(54) SYSTEM AND METHOD TO DETECT LINE-OF-SIGHT DETECTION TOOL FOR A SATELLITE

(71) Applicant: Rakuten Mobile, Inc., Tokyo (JP)

(72) Inventors: Warangrat WIRIYA, Tokyo (JP); Bingxuan ZHAO, Tokyo (JP); Shanfeng LI, Tokyo (JP); Hyungmin HA, Tokyo (JP); Ryoji OSAKA, Tokyo (JP)

(21) Appl. No.: 18/820,159

(22) Filed: Aug. 29, 2024

(51) Int. Cl. H04W 64/00; H04W 84/06

(52) U.S. Cl. CPC H04W 64/003; H04W 84/06

(57) ABSTRACT

A method and system of detecting a line-of-sight (LOS) of a satellite signal, including receiving of a geographic data into a software application. The method and system including receiving of a plurality of parameters into the software application. The method and system including identifying of, based on the geographic data and the plurality of parameters, a path of the LOS between a satellite and a candidate location for a ground/mobile terminal. The method and system including selecting of the candidate location for the ground/mobile terminal as a construction location for constructing of a ground/mobile terminal.

### FIELD

The present disclosure relates to a system and method to detect line-of-sight for a satellite.

### BACKGROUND

Satellite technologies, such as low earth orbit (LEO) satellites are emerging as the wireless backhauls for telecommunication and cellular networks. This type of satellite technology opens up global communication by providing access to telecommunication and cellular networks in remote areas of the world, which would otherwise be difficult to develop and expensive to maintain, if ground-based communication hardware were implemented, such as fiber optic cables. LEO satellites are able to be utilized as wireless backhauls based on line-of-sight (“LOS”) with a ground/mobile terminal. LEO satellites orbit the Earth in approximately 1.5 hours at approximately 1,400 kilometers above sea level. LEO satellites offer advantages over geostationary satellites by having reduced latency being closer to Earth, increased data transmission speeds, and low launching costs.

### SUMMARY

In at least one embodiment, a method of detecting a line-of-sight (LOS) of a satellite signal, including receiving of a geographic data into a software application. The method of detecting a line-of-sight (LOS) of a satellite signal further includes receiving of a plurality of parameters into the software application. The method of detecting a line-of-sight (LOS) of a satellite signal further includes identifying of, based on the geographic data and the plurality of parameters, a path of the LOS between a satellite and a candidate location for a ground/mobile terminal. The method of detecting a line-of-sight (LOS) of a satellite signal further includes selecting of the candidate location for the ground/mobile terminal as a construction location for constructing of a ground/mobile terminal.

In at least one embodiment, a LOS detection system of a satellite signal, configured to receive a geographic data into a software application. The LOS detection system of a satellite signal is configured to receive a plurality of parameters into the software application. The LOS detection system of a satellite signal is configured to identify, based on the geographic data and the plurality of parameters, a path of the LOS between a satellite and a candidate location for a ground/mobile terminal. The LOS detection system of a satellite signal is configured to select the candidate location for the ground/mobile terminal as a construction location for constructing of a ground/mobile terminal.

In at least one embodiment, a non-transitory computer-readable media having computer-readable instructions stored thereon, which in response to being executed causes a LOS detection system of a satellite signal to perform operations including receiving of a geographic data into a software application. A non-transitory computer-readable media having computer-readable instructions stored thereon, which in response to being executed causes a LOS detection system of a satellite signal to perform operations including receiving of a plurality of parameters into the software application. A non-transitory computer-readable media having computer-readable instructions stored thereon, which in response to being executed causes a LOS detection system of a satellite signal to perform operations including identifying of, based on the geographic data and the plurality of parameters, a path of the LOS between a satellite and a candidate location for a ground/mobile terminal. A non-transitory computer-readable media having computer-readable instructions stored thereon, which in response to being executed causes a LOS detection system of a satellite signal to perform operations including selecting of the candidate location for the ground/mobile terminal as a construction location for constructing of a ground/mobile terminal.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIG. 1 is a diagram of an example flowchart 100, in accordance with some embodiments.

FIG. 2 is a diagram of example components of 200, in accordance with some embodiments.

FIG. 3 is an example of a high-level functional block diagram of a processor-based system, in accordance with some embodiments.

FIG. 4 is a diagram of a system for a LOS detection system, in accordance with some embodiments.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B. The foregoing disclosure provides illustration and description but is not intended to be exhaustive or to limit the implementations to the precise form disclosed. Modifications and variations are possible in light of the above disclosure or may be acquired from practice of the implementations.

LEO satellite technology is emerging as the wireless backhauls of telecommunication and cellular networks so as to provide mobile connectivity in remote geographic regions that would otherwise be difficult to access and develop. But equipment in the form of ground/mobile terminals still needs to be installed, which presents challenges of identifying candidate locations for installing the equipment. These challenges stem from allocating resources to physically survey candidate locations to determine LOS between a ground/mobile terminal and an LEO satellite. As LEO satellite technology continues to emerge, the development of these networks requires thousands of candidate locations to be surveyed. The surveying of potentially thousands of locations in developing a network is impractical for a variety of reasons, especially in terms of cost and time.

In addressing these aforementioned challenges, the present disclosure relates to a LOS detection system which is a tool able to overcome the aforementioned challenges by determining candidate locations for ground/mobile terminals based on actual terrain and building data and assumptions data which are able to be extrapolated based on terrain and building data.

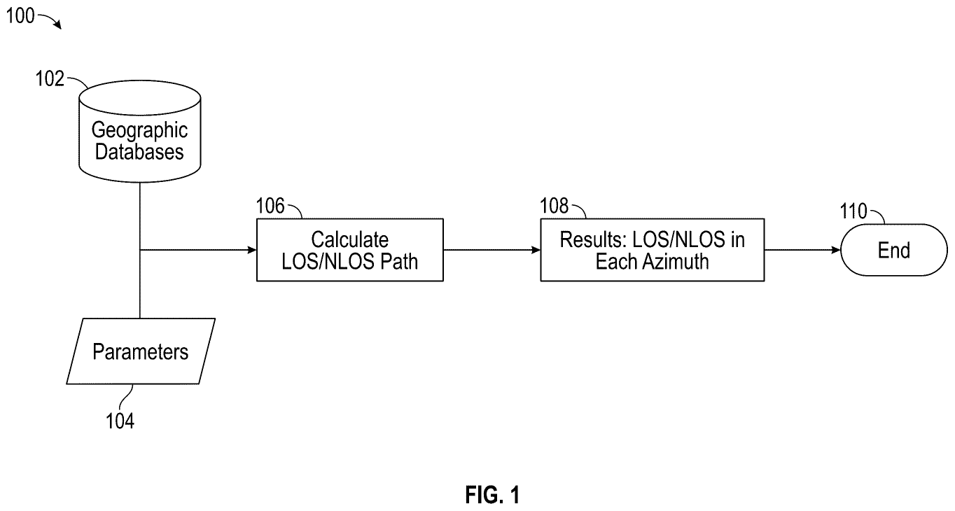

FIG. 1 is a diagram of an example flowchart 100, in accordance with some embodiments.

Feature 102 refers to a geographic database in the line-of-sight (“LOS”) detection system. The geographic database includes terrain elevation above sea level data and building data. In at least one embodiment, the geographic database includes data from the Geospatial Information Authority of Japan (GS) and data from the Open Street Map (OSM).

Feature 104 refers to input parameters in the line-of-sight (“LOS”) detection system. The input parameters include at least three categories of input parameters including ground/mobile terminal parameters, surrounding environment assumption parameters, and LOS checking resolution parameters. The ground/mobile terminal parameters include latitude, longitude, antenna height, and minimum ground elevation in each direction (azimuth). The surrounding environment assumption parameters include average trees height and horizontal distance from antenna to trees. The LOS checking resolution parameters include azimuth increment, elevation increment, distance increment, and limited distance. In some embodiments, other parameters are able to be selected from Table 1.

TABLE 1

| Parameters | Description | Interval | Notes |
|---|---|---|---|
| Lat(deg) | Latitude of | x = [−90, 90]; x ∈ [symbol] | |
| | ground/mobile terminals | | |
| Lon(deg) | Longitude of | x = [−180, 180]; x ∈ [symbol] | |
| | ground/mobile terminals | | |
| Antenna | Antenna height above | x = (0, ∞); x ∈ [symbol] | |
| Height(m) | ground level | | |
| Tree | Tree height above ground | x = [0, ∞)x ∈ [symbol] | When |
| Height(m) | level | | Obstacle |
| | | | Type is not |
| | | | Building. |
| Azimuth | Increment step of azimuth | x = (0, 360); x ∈ [symbol] | |
| Increment(deg) | angle for checking | | |
| Elevation | Increment step of | x = (0, 90); x ∈ [symbol] | |
| Increment(deg) | elevation angle for | | |
| | checking | | |
| Distance | Distance increment step | x = | |
| Increment(m) | for checking | [5, Limited Distance × 1000); x ∈ [symbol] | |
| Distance To | Horizontal distance from | x = (0, ∞) x ∈ [symbol] | When |
| Tree(m) | BS to trees | | Obstacle |
| | | | Type is not |
| | | | Building. |
| Limited | Limited distance of | x = [1, 5]; x ∈ [symbol] | |
| Distance(km) | checked range | | |
| Min EL | The minimum value of | x = (0, 90) x ∈ [symbol] | When Min |
| Angle(deg) | the elevation angle range. | | EL Data |
| | | | Pattern is |
| | | | Fixed |
| | | | mode. |

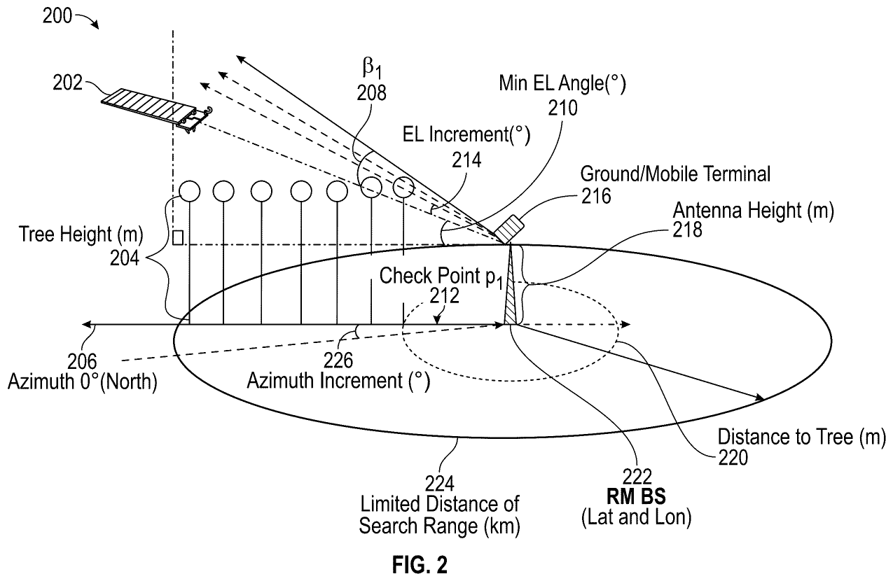

Feature 106 refers to calculation of the LOS between a satellite and a candidate for a ground/mobile terminal, discussed in further detail in FIG. 2.

Feature 108 refers to a result of the calculations of the LOS between a satellite and a candidate for a ground/mobile terminal, discussed in further detail in FIG. 2.

Feature 110 refers to an end of the method in identifying a candidate location for a ground/mobile terminal having an unobstructed path of LOS, and informs the user to select the candidate location of the ground/base terminal as a construction location of the ground/base terminal for actual, real world construction of the ground/base terminal at a latitude and longitude coordinates of a geographic location.

FIG. 2 is a diagram of example components of 200, in accordance with some embodiments.

Feature 202 refers to a representation of a satellite which is able to transmit a signal to a ground/mobile terminal. In at least one embodiment, the representation of the satellite is of an actual satellite in orbit around the earth, for example, Space X/Starlink low earth orbit satellites. In at least one embodiment, the representation of the satellite is of a simulated/modeled satellite which has not been launched into orbit.

Feature 204 refers to a height of a geographic obstacle, for example, a tree. In at least one embodiment, the LOS detection system is able to receive information relating to a height of a geographic obstacle. In at least one embodiment, the LOS detection system is able to receive information relating to a height of each geographic obstacle of a plurality of geographic obstacles.

In at least one embodiment, the LOS detection system is, in addition to the geographic database data 102, able to make assumptions of average heights of geographic obstacles and horizontal distances from the ground/mobile terminal to a geographic obstacle.

In at least one embodiment, the LOS detection system is able to utilize the geographic obstacles from the geographic database data 102 in combination with the assumptions data to determine the LOS in an urban environment. In at least one embodiment, the LOS detection system is able to utilize the geographic obstacles from the geographic database data 102 in combination with the assumptions data to determine the LOS in a suburban environment. In at least one embodiment, the LOS detection system is able to utilize the geographic obstacles from the geographic database data 102 in combination with the assumptions data to determine the LOS in a residential environment. In at least one embodiment, the LOS detection system is able to utilize the geographic obstacles from the geographic database data 102 in combination with the assumptions data to determine the LOS in a village environment. In at least one embodiment, the LOS detection system is able to utilize the geographic obstacles from the geographic database data 102 in combination with the assumptions data to determine the LOS in a rural environment. In at least one embodiment, the LOS detection system is able to utilize the geographic obstacles from the geographic database data 102 in combination with the assumptions data to determine the LOS in a rural wooded environment.

In at least one embodiment, the LOS detection system is able to utilize the geographic obstacles from the geographic database data 102 to determine the LOS in an open area with little to no buildings and/or trees.

In at least one embodiment, the LOS detection system is able to utilize the geographic obstacles from the geographic database data 102 in combination with the assumptions data to determine the LOS in an area where there is a concentration of trees but no buildings/structures.

In at least one embodiment, the LOS detection system is able to utilize the building/structural obstacles from the geographic database data 102 to determine the LOS in an area which is localized, primarily flat and having buildings where there is little variation in terrain height.

In at least one embodiment, the LOS detection system is able to utilize the building/structural obstacles from the geographic database data 102 in combination with the assumptions data to determine the LOS in an area which is localized, primarily flat and having both buildings and trees where there is little variation in terrain height.

In at least one embodiment, the LOS detection system is able to utilize the building/structural obstacles and the geographic obstacles from the geographic database data 102 to determine the LOS in an area which is primarily hilly and having buildings but little to no trees.

In at least one embodiment, the LOS detection system is able to utilize the building/structural obstacles and the geographic obstacles from the geographic database data 102 in combination with the assumptions data to determine the LOS in an area which is primarily hilly and having both buildings and trees.

In at least one embodiment, the LOS detection system is, instead of real data of geographic obstacles from the geographic database data 102, able to make assumptions of average heights of geographic obstacles and horizontal distances from the ground/mobile terminal to a geographic obstacle.

Feature 206 refers to an azimuth with respect to a candidate location of the ground/mobile terminal. In order to receive the information relating to height of a geographic obstacle or a plurality of geographic obstacles, the LOS detection system considers the aforementioned information within an azimuth. An azimuth is an angular measurement relative to a cardinal direction, for example north/0 degrees, of a celestial object with respect a point on the surface of the earth, such as the candidate location of a ground/mobile terminal. In at least one embodiment, the system is able to determine at a first azimuth, at a check point of a first obstacle, an elevation angle of the first obstacle based on a height of the first obstacle. In at least one embodiment, the height of the first obstacle is obtained from the geographic database.

Feature 208 refers to a minimum elevation angle (β₁) such that the ground/mobile terminal would be able to receive an unobstructed signal from a satellite, and vice versa.

Feature 210 refers to a minimum elevation angle of the ground/mobile terminal before any incremental adjustments. In at least one embodiment, the system is able to perform a comparison of the elevation angle of the first obstacle to the minimum elevation angle of the ground/mobile terminal at an azimuth of, for example, 0 degrees. In at least one embodiment, the performing of the comparison between the elevation angle of the geographic obstacle and the minimum elevation angle of the ground/mobile terminal occurs within the same azimuth because a different azimuth of the ground/mobile terminal could have a different minimum elevation angle than an adjacent azimuth. In the latter case of differing minimum elevations angles in an adjacent azimuth, a ground/mobile terminal is able to use different minimum elevations for each direction/azimuth due to uplink interference to geostationary satellites. If a pair of azimuths and minimum elevations do not match to the azimuth increment step, there are at least five options to determine minimum elevation for each azimuth, which are described below and referred to in the graph below.

In at least one embodiment, in a fixed mode option, each azimuth is able to use a given elevation value. In at least one embodiment, in a lower mode option, a lower bound of each step is able to be used to provide the azimuth. In at least one embodiment, in a an upper mode option, an upper bound of each step is able to be used to provide the azimuth. In at least one embodiment, in a linear mode option, a linear curve is able to be fitted to calculate and provide the azimuth. In at least one embodiment, in a versatile curve option, is able to be used to calculate minimum elevation angles in each azimuth by determining curve fitting from a user.

In at least one embodiment, when the elevation angle of the geographic obstacle is greater than or equal to the minimum elevation angle of the ground/mobile terminal, the elevation angle of the ground/mobile terminal is able to be increased from a threshold or minimum value until the value is greater than or equal to the elevation angle of the geographic obstacle. The increasing of the elevation able is able to be performed at the increments of Table 1 referred to above. The elevation angle of the ground/mobile terminal is increased to a new minimum elevation angle (feature 208), β₁, such that the satellite signal is unobstructed.

In at least one embodiment, when the elevation angle of the geographic obstacle is less than or equal to the minimum elevation angle of the ground/mobile terminal, the LOS detection system proceeds to a next check point, which could be the next geographic obstacle moving outwardly along the radius from the first check point of the first geographic obstacle with respect to the ground/mobile terminal. The elevation angle of the ground/mobile terminal is able to be increased from a threshold or minimum value until the value is greater than or equal to the elevation angle of the second/subsequent geographic obstacle. The increasing of the elevation is able to be performed at the increments of Table 1 referred to above. The distance between a first checkpoint and a second check point is able to be determined from Table 1 referred to above. The elevation angle of the ground/mobile terminal is increased to a new minimum elevation angle (feature 208), β₂, such that the satellite signal remains unobstructed.

The above steps are performed for each subsequent checkpoint and minimum elevation angle of an entirety of geographic obstacles along a respective azimuth up to the limited distance as measured via radius from the ground/mobile terminal in the center. In at least one embodiment, the LOS detection system compares the minimum elevation angles, β, of all the check points, and selects the highest β minimum elevation such that the satellite signal would not be obstructed. The entirety of the above method is repeated for each azimuth of the ground/mobile terminal.

Feature 212 refers to a check point or first check point at a geographic obstacle along an azimuth with respect to the ground/mobile terminal.

Feature 214 refers to incremental adjustments of the minimum elevation angle of the ground/mobile terminal until an unobstructed signal from a satellite is able to be acquired, and vice versa.

Feature 216 refers to a ground/mobile terminal at candidate location for construction thereof. In at least one embodiment of the LOS detection system, a candidate location of a ground/mobile terminal is received by the software application.

Feature 218 refers to a height of an antenna of a ground/mobile terminal. In at least one embodiment of the LOS detection system, the ground/mobile terminal includes an antenna, and a height of the antenna is received by the software application. In at least one embodiment of the LOS detection system, the height of the antenna is initially determined based on a geographic obstacle or plurality of geographic obstacles in proximity to the ground/mobile terminal.

Feature 220 refers to a distance from the ground/mobile terminal to a check point or first check point of a geographic obstacle. In at least one embodiment of the LOS detection system, the system is able to set a distance radius with respect latitude and longitude coordinate of a candidate location of a ground/mobile terminal.

Feature 222 refers to a latitude and longitudinal coordinates of a candidate location for a ground/mobile terminal.

Feature 224 refers to a limited distance radius with respect a candidate location of a ground/mobile terminal in which a geographic obstacle is able to affect the LOS between a satellite and a ground/mobile terminal.

Feature 226 refers to an increment of an azimuth with respect the candidate location of the ground/base terminal.

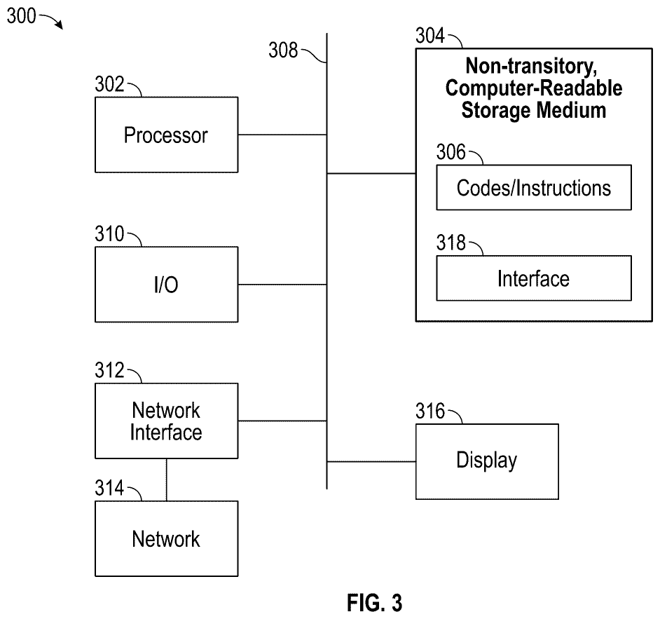

FIG. 3 is a high-level functional block diagram of a processor-based system, in accordance with some embodiments.

FIG. 3 is a diagram of a system for implementing an LOS detection system, in accordance with some embodiments.

In some embodiments, system 300 is a general-purpose computing device including a hardware processing circuitry 302 and a non-transitory, computer-readable storage medium 304. Storage medium 304, amongst other things, is encoded with, i.e., stores, computer instructions 306, i.e., a set of executable instructions such as a AI recommended auto-assurance policy manager. Execution of instructions 306 by hardware processing circuitry 302 represents (at least in part) a tool which implements a portion or all the methods, such as methods 100 and 200, described herein in accordance with one or more embodiments (hereinafter, the noted processes and/or methods).

Hardware processing circuitry 302 is electrically coupled to a computer-readable storage medium 304 via a bus 308. Hardware processing circuitry 302 is further electrically coupled to an I/O interface 310 by bus 308. A network interface 312 is further electrically connected to processing circuitry 302 via bus 308. Network interface 312 is connected to a network 314, so that processing circuitry 302 and computer-readable storage medium 304 connect to external elements via network 314. Processing circuitry 302 is configured to execute computer instructions 306 encoded in computer-readable storage medium 304 in order to cause system 300 to be usable for performing the noted processes and/or methods, such as methods 100 and 200, of FIGS. 1 and 2. In one or more embodiments, processing circuitry 302 is a central processing unit (CPU), a multi-processor, a distributed processing system, an application specific integrated circuit (ASIC), and/or a suitable processing unit.

In one or more embodiments, computer-readable storage medium 304 is an electronic, magnetic, optical, electromagnetic, infrared, and/or a semiconductor system (or apparatus or device). For example, computer-readable storage medium 304 includes a semiconductor or solid-state memory, a magnetic tape, a removable computer diskette, a random-access memory (RAM), a read-memory (ROM), a rigid magnetic disk, and/or an optical disk. In one or more embodiments using optical disks, computer-readable storage medium 304 includes a compact disk-read memory (CD-ROM), a compact disk-read/write (CD-R/W), and/or a digital video disc (DVD).

In one or more embodiments, storage medium 304 stores computer instructions 306 configured to cause system 300 to be usable for performing a portion or the noted processes and/or methods. In one or more embodiments, storage medium 304 further stores information, such as a AI recommended auto-assurance policy engine which facilitates performing the noted processes and/or methods.

System 300 includes I/O interface 310. I/O interface 310 is coupled to external circuitry. In one or more embodiments, I/O interface 310 includes a keyboard, keypad, mouse, trackball, trackpad, touchscreen, cursor direction keys and/or other suitable I/O interfaces are within the contemplated scope of the disclosure for communicating information and commands to processing circuitry 302.

System 300 further includes network interface 312 coupled to processing circuitry 302. Network interface 312 allows system 300 to communicate with network 314, to which one or more other computer systems are connected. Network interface 312 includes wireless network interfaces such as BLUETOOTH, WIFI, WIMAX, GPRS, or WCDMA; or wired network interfaces such as ETHERNET, USB, or IEEE-864. In one or more embodiments, noted processes and/or methods, are implemented in two or more system 300.

System 300 is configured to receive information through I/O interface 310. The information received through I/O interface 310 includes one or more of instructions, data, and/or other parameters for processing by processing circuitry 302. The information is transferred to processing circuitry 302 via bus 308. System 300 is configured to receive information related to a UI, such as UI 318, through I/O interface 310. The information is stored in computer-readable medium 304 as user interface (UI) 308.

In some embodiments, the noted processes and/or methods are implemented as a standalone software application for execution by processing circuitry. In some embodiments, the noted processes and/or methods are implemented as a software application that is a part of an additional software application. In some embodiments, the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

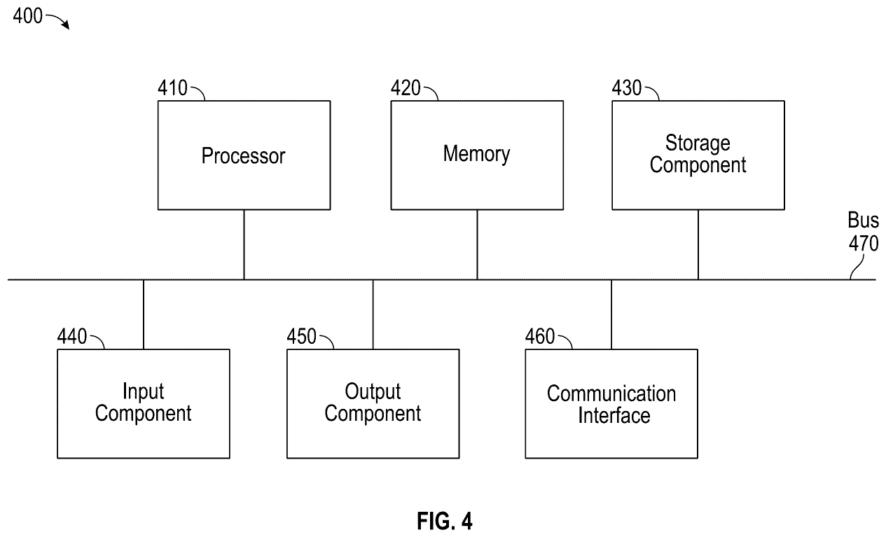

FIG. 4 illustrates an exemplary embodiment of a device 400. As shown in FIG. 4, the device 400 may include a processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and one or more single core processors, a distributed processing system, or the like. The processor 410 may be a Central Processing Unit (CPU) a graphics processing unit (GPU), an accelerated processing unit (APU), an application-specific integrated circuit (ASIC), or another type of processing component.

Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 causes the processor 410 to perform method steps of an exemplary embodiment described herein.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as via user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, and/or one or more light-emitting diodes (LEDs).

Communication interface 460 is an interface that provides a communication connection to other devices. The connection by the communication interface 460 can be a wired connection, a wireless connection, or a combination of wired and wireless connections, and can be a direct connection or an indirect connection via a communication network that exists between other devices. In other words, the standard of the communication interface 760 is not limited.

The bus 470 acts as an interconnect between the processor 410, the memory 420, the storage component 430, the input component 440, the output component 450, and the communication interface 460 of the device 400.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

### Supplemental Note 1

A method of detecting a line-of-sight (LOS) of a satellite signal, including receiving of a geographic data into a software application. The method of detecting a line-of-sight (LOS) of a satellite signal, including receiving of a plurality of parameters into the software application. The method of detecting a line-of-sight (LOS) of a satellite signal, including identifying of, based on the geographic data and the plurality of parameters, a path of the LOS between a satellite and a candidate location for a ground/mobile terminal. A method of detecting a line-of-sight (LOS) of a satellite signal, including selecting of the candidate location for the ground/mobile terminal as a construction location for constructing of a ground/mobile terminal.

### Supplemental Note 2

The method of detecting the LOS of the satellite signal according to Supplemental Note 1, wherein the receiving of the geographic data includes receiving of a geographic obstruction data, a terrain elevation above sea level data, and a building data.

### Supplemental Note 3

The method of detecting the LOS of the satellite signal according to Supplemental Notes 1 or 2, wherein the receiving of the plurality of parameters includes receiving of a ground/mobile terminal data, a surrounding environment assumption data, and a LOS checking resolution data.

### Supplemental Note 4

The method of detecting the LOS of the satellite signal according to Supplemental Notes 1-3, wherein the receiving of the ground/mobile terminal data includes receiving of a latitude, a longitude, an antenna height, and a minimum ground elevation in each direction (azimuths).

### Supplemental Note 5

The method of detecting the LOS of the satellite signal according to Supplemental Notes 1-4, wherein the receiving of the surrounding environment assumption data includes inputting of an average obstacle height, and a horizontal distance between the candidate location for the ground/mobile terminal and a geographic obstruction.

### Supplemental Note 6

The method of detecting the LOS of the satellite signal according to Supplemental Notes 1-5, wherein the receiving of the LOS checking resolution data includes receiving of an azimuth increment, an elevation increment, a distance increment, and a limited distance.

### Supplemental Note 7

The method of detecting the LOS of the satellite signal according to Supplemental Notes 1-6, wherein the calculating of the path of the LOS includes calculating of, at a respective check point of the geographic obstacle, an elevation angle of the geographic obstacle based on a height of the geographic obstacle at a respective first azimuth. The method of detecting a line-of-sight (LOS) of a satellite signal, including performing of a comparison of the elevation angle of the geographic obstacle to a minimum elevation angle of the ground/mobile terminal at the first respective azimuth, and in response to the elevation angle of the geographic obstacle being greater than or equal to the minimum elevation angle of the ground/mobile terminal performing of an increase of an elevation angle of the ground/mobile terminal from the minimum elevation angle until the elevation angle of the ground/mobile terminal is greater than or equal to the elevation angle of the geographic obstacle. The method of detecting a line-of-sight (LOS) of a satellite signal, including repeating calculating, performing of a comparison, and performing of an increase of the elevation angle of the ground/mobile terminal with respect to an elevation angle of a geographic obstacle at each respective checkpoint and azimuth so the path of the LOS for the satellite signal is not obstructed.

### Supplemental Note 8

A LOS detection system of a satellite signal, configured to. receive a geographic data into a software application. The LOS detection system of a satellite signal configured to receive a plurality of parameters into the software application. The LOS detection system of a satellite signal configured to identify, based on the geographic data and the plurality of parameters, a path of the LOS between a satellite and a candidate location for a ground/mobile terminal. The LOS detection system of a satellite signal configured to select the candidate location for the ground/mobile terminal as a construction location for constructing of a ground/mobile terminal.

### Supplemental Note 9

The LOS detection system of the satellite signal according to Supplemental Note 8, wherein the geographic data includes a geographic obstruction data, a terrain elevation above sea level data, and a building data.

### Supplemental Note 10

The LOS detection system of the satellite signal according to Supplemental Notes 8 or 9, wherein the plurality of parameters includes a ground/mobile terminal data, a surrounding environment assumption data, and a LOS checking resolution data.

### Supplemental Note 11

The LOS detection system of the satellite signal according to Supplemental Notes 8-10, wherein the ground/mobile terminal data comprises a latitude, a longitude, an antenna height, and a minimum ground elevation in each direction (azimuths).

### Supplemental Note 12

The LOS detection system of the satellite signal according to Supplemental Notes 8-11, wherein the surrounding environment assumption data includes an average obstacle height, and a horizontal distance between the candidate location for the ground/mobile terminal and a geographic obstruction.

### Supplemental Note 13

The LOS detection system of the satellite signal according to Supplemental Notes 8-12, wherein the LOS checking resolution data includes an azimuth increment, an elevation increment, a distance increment, and a limited distance.

### Supplemental Note 14

The LOS detection system of the satellite signal according to Supplemental Notes 8-13, further configured to calculate, at a respective check point of the geographic obstacle, an elevation angle of the geographic obstacle based on a height of the geographic obstacle at a respective first azimuth. The LOS detection system of the satellite signal further configured to perform a comparison of the elevation angle of the geographic obstacle to a minimum elevation angle of the ground/mobile terminal at the first respective azimuth, and in response to the elevation angle of the geographic obstacle being greater than or equal to the minimum elevation angle of the ground/mobile terminal perform an increase of an elevation angle of the ground/mobile terminal from the minimum elevation angle until the elevation angle of the ground/mobile terminal is greater than or equal to the elevation angle of the geographic obstacle. The LOS detection system of the satellite signal further configured to repeat calculation, perform a comparison, and perform an increase of the elevation angle of the ground/mobile terminal with respect to an elevation angle of a geographic obstacle at each respective checkpoint and azimuth so the path of the LOS for the satellite signal is not obstructed.

### Supplemental Note 15

A non-transitory computer-readable media having computer-readable instructions stored thereon, which in response to being executed causes a LOS detection system of a satellite signal to perform operations including receiving of a geographic data into a software application. The non-transitory computer-readable media having computer-readable instructions stored thereon, which in response to being executed causes a LOS detection system of a satellite signal to perform operations including receiving of a plurality of parameters into the software application. The non-transitory computer-readable media having computer-readable instructions stored thereon, which in response to being executed causes a LOS detection system of a satellite signal to perform operations including identifying of, based on the geographic data and the plurality of parameters, a path of the LOS between a satellite and a candidate location for a ground/mobile terminal. non-transitory computer-readable media having computer-readable instructions stored thereon, which in response to being executed causes a LOS detection system of a satellite signal to perform operations including selecting of the candidate location for the ground/mobile terminal as a construction location for constructing of a ground/mobile terminal.

### Supplemental Note 16

The non-transitory computer-readable media according to Supplemental Note 15, wherein the receiving of the geographic data includes receiving of a geographic obstruction data, a terrain elevation above sea level data, and a building data, and the receiving of the plurality of parameters comprises receiving of a ground/mobile terminal data, a surrounding environment assumption data, and a LOS checking resolution data.

### Supplemental Note 17

The non-transitory computer-readable media according to Supplemental Notes 15 or 16, wherein the receiving of the ground/mobile terminal data includes receiving of a latitude, a longitude, an antenna height, and a minimum ground elevation in each direction (azimuths).

### Supplemental Note 18

The non-transitory computer-readable media according to Supplemental Notes 15-17, wherein the receiving of the surrounding environment assumption data includes receiving of an average obstacle height, and a horizontal distance between the candidate location for the ground/mobile terminal and a geographic obstruction.

### Supplemental Note 19

The non-transitory computer-readable media according to Supplemental Notes 15-18, wherein the receiving of the LOS checking resolution data includes receiving of an azimuth increment, an elevation increment, a distance increment, and a limited distance.

### Supplemental Note 20

The non-transitory computer-readable media according to Supplemental Notes 15-19, wherein the calculating of the path of the LOS includes calculating of, at a respective check point of the geographic obstacle, an elevation angle of the geographic obstacle based on a height of the geographic obstacle at a respective first azimuth. The non-transitory computer-readable media having computer-readable instructions stored thereon, which in response to being executed causes a LOS detection system of a satellite signal to perform operations including performing of a comparison of the elevation angle of the geographic obstacle to a minimum elevation angle of the ground/mobile terminal at the first respective azimuth, and in response to the elevation angle of the geographic obstacle being greater than or equal to the minimum elevation angle of the ground/mobile terminal performing of an increase of an elevation angle of the ground/mobile terminal from the minimum elevation angle until the elevation angle of the ground/mobile terminal is greater than or equal to the elevation angle of the geographic obstacle. The non-transitory computer-readable media having computer-readable instructions stored thereon, which in response to being executed causes a LOS detection system of a satellite signal to perform operations including repeating calculating, performing of a comparison, and performing of an increase of the elevation angle of the ground/mobile terminal with respect to an elevation angle of a geographic obstacle at each respective checkpoint and azimuth so the path of the LOS for the satellite signal is not obstructed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of detecting a line-of-sight (LOS) of a satellite signal, comprising:
receiving of a geographic data into a software application;
receiving of a plurality of parameters into the software application;
identifying of, based on the geographic data and the plurality of parameters, a path of the LOS between a satellite and a candidate location for a ground/mobile terminal; and
selecting of the candidate location for the ground/mobile terminal as a construction location for constructing of a ground/mobile terminal.

2. The method of detecting the LOS of the satellite signal according to claim 1, wherein the receiving of the geographic data comprises receiving of a geographic obstruction data, a terrain elevation above sea level data, and a building data.

3. The method of detecting the LOS of the satellite signal according to claim 1, wherein the receiving of the plurality of parameters comprises receiving of a ground/mobile terminal data, a surrounding environment assumption data, and a LOS checking resolution data.

4. The method of detecting the LOS of the satellite signal according to claim 3, wherein the receiving of the ground/mobile terminal data comprises receiving of a latitude, a longitude, an antenna height, and a minimum ground elevation in each direction (azimuths).

5. The method of detecting the LOS of the satellite signal according to claim 3, wherein the receiving of the surrounding environment assumption data comprises receiving of an average obstacle height, and a horizontal distance between the candidate location for the ground/mobile terminal and a geographic obstruction.

6. The method of detecting the LOS of the satellite signal according to claim 3, wherein the receiving of the LOS checking resolution data comprises receiving of an azimuth increment, an elevation increment, a distance increment, and a limited distance.

7. The method of detecting the LOS of the satellite signal according to claim 2, wherein the identifying of the path of the LOS further comprises:
calculating of, at a respective check point of the geographic obstacle, an elevation angle of the geographic obstacle based on a height of the geographic obstacle at a respective first azimuth;
performing of a comparison of the elevation angle of the geographic obstacle to a minimum elevation angle of the ground/mobile terminal at the first respective azimuth, and
in response to the elevation angle of the geographic obstacle being greater than or equal to the minimum elevation angle of the ground/mobile terminal performing of an increase of an elevation angle of the ground/mobile terminal from the minimum elevation angle until the elevation angle of the ground/mobile terminal is greater than or equal to the elevation angle of the geographic obstacle; and
repeating calculating, performing of a comparison, and performing of an increase of the elevation angle of the ground/mobile terminal with respect to an elevation angle of a geographic obstacle at each respective checkpoint and azimuth so the path of the LOS for the satellite signal is not obstructed.

8. A LOS detection system of a satellite signal, configured to:
receive a geographic data into a software application;
receive a plurality of parameters into the software application;
identify, based on the geographic data and the plurality of parameters, a path of the LOS between a satellite and a candidate location for a ground/mobile terminal; and
select the candidate location for the ground/mobile terminal as a construction location for constructing of a ground/mobile terminal.

9. The LOS detection system of the satellite signal according to claim 8, wherein the geographic data comprises a geographic obstruction data, a terrain elevation above sea level data, and a building data.

10. The LOS detection system of the satellite signal according to claim 8, wherein the plurality of parameters comprises a ground/mobile terminal data, a surrounding environment assumption data, and a LOS checking resolution data.

11. The LOS detection system of the satellite signal according to claim 10, wherein the ground/mobile terminal data comprises a latitude, a longitude, an antenna height, and a minimum ground elevation in each direction (azimuths).

12. The LOS detection system of the satellite signal according to claim 10, wherein the surrounding environment assumption data comprises an average obstacle height, and a horizontal distance between the candidate location for the ground/mobile terminal and a geographic obstruction.

13. The LOS detection system of the satellite signal according to claim 10, wherein the LOS checking resolution data comprises an azimuth increment, an elevation increment, a distance increment, and a limited distance.

14. The LOS detection system of the satellite signal according to claim 9, further configured to:
calculate, at a respective check point of the geographic obstacle, an elevation angle of the geographic obstacle based on a height of the geographic obstacle at a respective first azimuth;
perform a comparison of the elevation angle of the geographic obstacle to a minimum elevation angle of the ground/mobile terminal at the first respective azimuth, and
in response to the elevation angle of the geographic obstacle being greater than or equal to the minimum elevation angle of the ground/mobile terminal perform an increase of an elevation angle of the ground/mobile terminal from the minimum elevation angle until the elevation angle of the ground/mobile terminal is greater than or equal to the elevation angle of the geographic obstacle; and
repeat calculation, perform a comparison, and perform an increase of the elevation angle of the ground/mobile terminal with respect to an elevation angle of a geographic obstacle at each respective checkpoint and azimuth so the path of the LOS for the satellite signal is not obstructed.

15. A non-transitory computer-readable media comprising computer-readable instructions stored thereon, which in response to being executed causes a LOS detection system of a satellite signal to perform operations comprising:
receiving of a geographic data into a software application;
receiving of a plurality of parameters into the software application;
identifying of, based on the geographic data and the plurality of parameters, a path of the LOS between a satellite and a candidate location for a ground/mobile terminal; and
selecting of the candidate location for the ground/mobile terminal as a construction location for constructing of a ground/mobile terminal.

16. The non-transitory computer-readable media according to claim 15, wherein
the receiving of the geographic data comprises receiving of a geographic obstruction data, a terrain elevation above sea level data, and a building data, and
the receiving of the plurality of parameters comprises receiving of a ground/mobile terminal data, a surrounding environment assumption data, and a LOS checking resolution data.

17. The non-transitory computer-readable media according to claim 16, wherein the receiving of the ground/mobile terminal data comprises receiving of a latitude, a longitude, an antenna height, and a minimum ground elevation in each direction (azimuths).

18. The non-transitory computer-readable media according to claim 17, wherein the receiving of the surrounding environment assumption data comprises receiving of an average obstacle height, and a horizontal distance between the candidate location for the ground/mobile terminal and a geographic obstruction.

19. The non-transitory computer-readable media according to claim 16, wherein the receiving of the LOS checking resolution data comprises receiving of an azimuth increment, an elevation increment, a distance increment, and a limited distance.

20. The non-transitory computer-readable media according to claim 16, wherein the identifying of the path of the LOS further comprises:
calculating of, at a respective check point of the geographic obstacle, an elevation angle of the geographic obstacle based on a height of the geographic obstacle at a respective first azimuth;
performing of a comparison of the elevation angle of the geographic obstacle to a minimum elevation angle of the ground/mobile terminal at the first respective azimuth, and
in response to the elevation angle of the geographic obstacle being greater than or equal to the minimum elevation angle of the ground/mobile terminal performing of an increase of an elevation angle of the ground/mobile terminal from the minimum elevation angle until the elevation angle of the ground/mobile terminal is greater than or equal to the elevation angle of the geographic obstacle; and
repeating calculating, performing of a comparison, and performing of an increase of the elevation angle of the ground/mobile terminal with respect to an elevation angle of a geographic obstacle at each respective checkpoint and azimuth so the path of the LOS for the satellite signal is not obstructed.
